(19) United States
(12) Patent Application Publication
(10) Pub. No.: US 2007/0245346 A1
(43) Pub. Date: Oct. 18, 2007

(54) SOFTWARE STARTUP LANGUAGE UNIFICATION APPARATUS, SOFTWARE STARTUP LANGUAGE UNIFICATION METHOD, AND PROGRAM

(75) Inventor: Hiroshi Shintoku, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/696,632

(22) Filed: Apr. 4, 2007

(30) Foreign Application Priority Data
Apr. 14, 2006 (JP) 2006-112283

(51) Int. Cl. G06F 9/445; G06F 9/44

(52) U.S. Cl. 717/174; 717/114

(57) ABSTRACT

A software display language unification apparatus includes: a selection unit configured to select a language to be used by software for display in accordance with a user's selection; a language management information storage unit configured to store language management information to be commonly checked by a plurality of pieces of software, the language management information being management information for a language to be used by software; a checking unit configured to check the stored language management information at the time of startup of software; and a display language determination unit configured to determine a display language to be used by software being started based on the checked language management information.

### BACKGROUND OF THE INVENTION

1. Field of the Invention

The present invention relates to a software startup language unification apparatus, a software startup language unification method, and a program capable of displaying related software using a language which a user has set when installing a driver without making the user perform a language setting operation.

2. Description of the Related Art

At the time of software installation, a user generally selects a startup language to be displayed when the software is started up, and performs installation of the software using the selected startup language. In addition, a technique is known which allows a user to easily select a display language to be displayed on an apparatus, and to easily switch display languages by storing display languages selected by users and resources (see, for example, Japanese Patent Laid-Open No. 2002-259104).

The above-described known technique includes a function of dynamically changing a display language of software.

However, in the known technique, display languages of a plurality of pieces of software that operate in conjunction with each other cannot be unified. A user is required to manually set a display language of each piece of software.

In addition, if a plurality of related pieces of software are downloaded from the Web and are then installed, a user is required to manually set a display language of each piece of software.

Thus, even if a plurality of pieces of software are related to each other and operate in conjunction with each other, the display languages thereof are not linked. A user is required to select a display language each time the user installs or starts up one of these pieces of software.

There are some pieces of software that are started using a language determined in accordance with the operating system (OS) locale. If a user wants to display these pieces of software with a language other than a language set in the OS locale, the user is required to reset the language of each piece of software.

In addition, if a plurality of related pieces of software are downloaded from the Web and are then installed, a user is required to individually set display languages of these pieces of software.

That is, in the known technique, even if a plurality of pieces of software are related to each other and operate in conjunction with each other, the display languages of these pieces of software cannot be automatically unified.

### SUMMARY OF THE INVENTION

The present invention provides a software startup language unification apparatus, a software startup language unification method, and a program capable of unifying display languages of a plurality of pieces of software that are related to each other or operate in conjunction with each other without making a user individually set the display languages of these pieces of software.

According to an aspect of the present invention, a software display language unification apparatus includes: a selection unit configured to select a language to be used by software for display in accordance with a user's selection; a language management information storage unit configured to store language management information to be commonly checked by a plurality of pieces of software, the language management information being management information for a language to be used by software; a checking unit configured to check the stored language management information at the time of startup of software; and a display language determination unit configured to determine a display language to be used by software being started based on the checked language management information.

According to another aspect of the present invention, a software display language unification method includes: selecting a language to be used by software for display in accordance with a user's selection; storing language management information to be commonly checked by a plurality of pieces of software in a memory, the language management information being management information for a language to be used by software for display; checking the language management information stored in the memory at the time of startup of software; and determining a display language to be used by software being started based on the checked language management information.

According to yet another aspect of the present invention, a program is stored on a computer-readable storage medium and includes computer-executable instructions for causing a computer to execute procedures for: selecting a language to be used by software for display in accordance with a user's selection; storing language management information to be commonly checked by a plurality of pieces of software in a memory, the language management information being management information for a language to be used by software for display; checking the language management information stored in the memory at the time of startup of software; and determining a display language to be used by software being started based on the checked language management information.

According to still yet another aspect of the present invention, a software display language unification apparatus includes: a selection unit configured to select a language to be used by software for display in accordance with a user's selection; a language management information storage unit configured to store language management information to be commonly checked by a plurality of pieces of software, the language management information being management information for a language to be used by software for display; a determination unit configured to determine whether the language management information has been stored; and a control unit configured to prevent the selection unit from selecting a language in accordance with a user's selection at the time of software installation when it is determined by the determination unit that the language management information has been stored.

According to still yet another aspect of the present invention, a software display language unification method includes: selecting a language to be used by software for display in accordance with a user's selection; storing language management information to be commonly checked by a plurality of pieces of software, the language management information being management information for a language to be used by software for display; determining whether the language management information has been stored; and preventing selecting a language in accordance with a user's selection at the time of software installation when it is determined that the language management information has been stored.

According to still yet another aspect of the present invention, a program is stored on a computer-readable medium and includes computer-executable instructions for causing a computer to execute procedures for: selecting a language to be used by software for display in accordance with a user's selection; storing language management information to be commonly checked by a plurality of pieces of software, the language management information being management information for a language to be used by software for display; determining whether the language management information has been stored; and preventing selecting a language in accordance with a user's selection at the time of software installation when it is determined that the language management information has been stored.

Display languages of a plurality of pieces of software that are related to each other and operate in conjunction with each other can be automatically unified without making a user individually perform display language settings of these correlated pieces of software.

Further features of the present invention will become apparent from the following description of exemplary embodiments with reference to the attached drawings.

### BRIEF DESCRIPTION OF THE DRAWINGS

FIG. 1 is a diagram showing a system including PCs that are software startup language unification apparatuses according to a first embodiment of the present invention.

FIG. 2 is a block diagram showing an exemplary configuration of one of the PCs.

FIG. 3 is a flowchart showing a processing procedure for installing a printer driver on one of the PCs.

FIG. 4 is a diagram showing an example of a startup language table.

FIG. 5 is a flowchart showing a processing procedure for determining a language at the time of startup of software.

FIG. 6 is a flowchart showing a processing procedure for writing information on a language selected by a user into a startup language table for software installed on a PC.

FIG. 7 is a diagram showing another example of a startup language table.

FIG. 8 is a flowchart showing a processing procedure for installing a printer driver on one of the PCs.

### DESCRIPTION OF THE EMBODIMENTS

Exemplary embodiments of the present invention will be described.

### First Embodiment

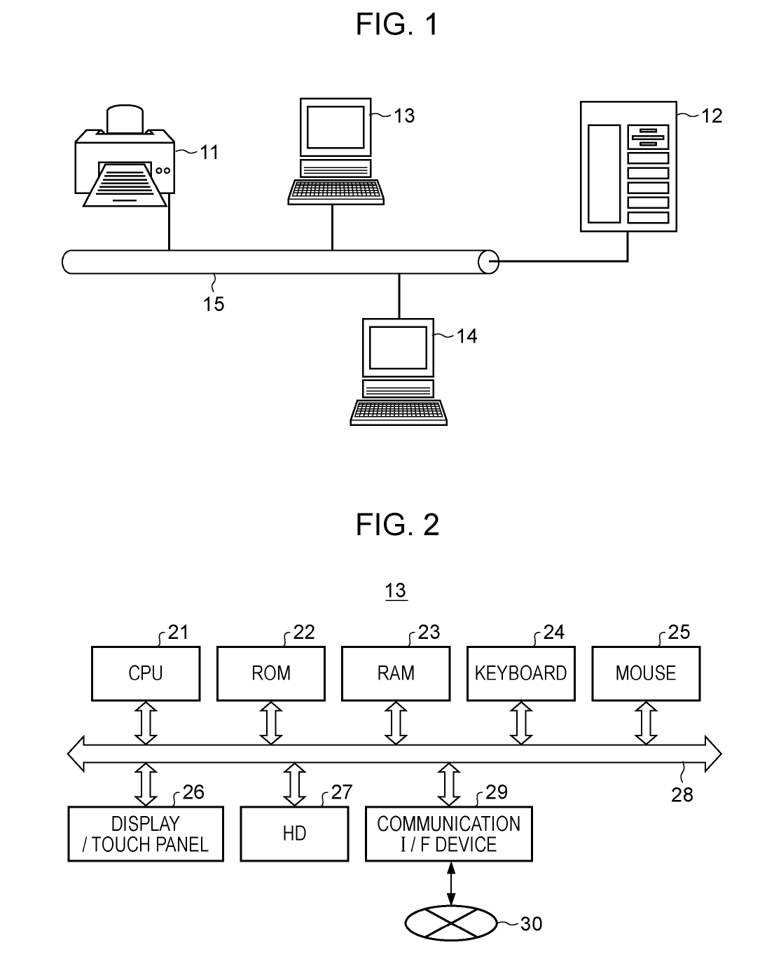

FIG. 1 is a diagram showing a system in which a printer 11, a server 12, and PCs 13 and 14 are connected to each other via a cable 15.

In the first exemplary embodiment, startup languages (display languages) of a plurality of pieces of software are unified in the PCs 13 and 14.

A startup language is a language displayed when an application is started up.

In FIG. 1, a plurality of pieces of software such as a printer driver for the printer 11 and application software are installed on the PCs 13 and 14 used by users. The server 12 is, for example, a DHCP server.

In the first embodiment, a case in which startup languages of a plurality of pieces of software such as a printer driver (hereinafter referred to as a driver) and application software installed on the PC 13 or 14 are unified will be described.

FIG. 2 is a block diagram showing an exemplary configuration of the PC 13 or 14.

The PC 13 or 14 is provided with a central processing unit (CPU) 21, a read-only memory (ROM) 22, a random access memory (RAM) 23, a keyboard 24, a pointing device 25 such as a mouse, a display 26, a hard drive (HD) 27, a bus 28, a communication interface (I/F) device 29, and a network 30.

The CPU 21 is a central processing unit for computation processing and control processing. The RAM 23 has an execution area into which a driver program and printer software are loaded and a program work area.

The keyboard 24 has keys with which an operator performs keyboard operations and data input operations. The pointing device 25 is a pointing device such as a mouse with which an operator provides operation instructions by clicking a button or moving a cursor on the display 26. The HD 27 is a storage device for storing a driver and software. The bus 28 interconnects devices included in an executive system.

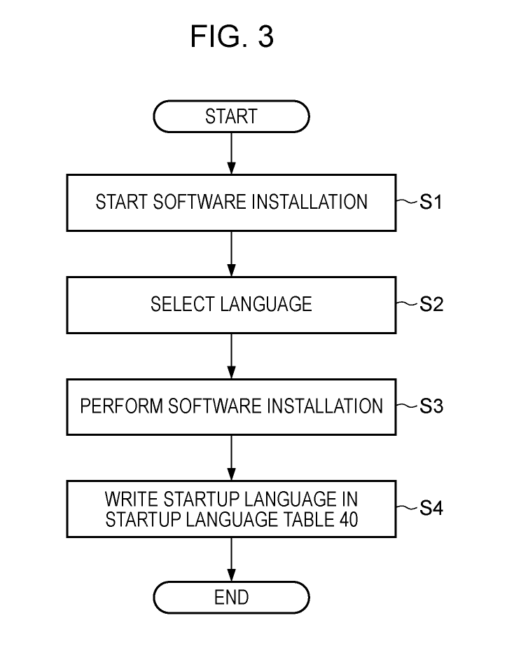

FIG. 3 is a flowchart showing a processing procedure for installing a printer driver on the PC 13 or 14.

In step S1, installation of software such as a driver is started. In step S2, a user selects a language from among a plurality of languages as a language with which the software such as a driver is displayed. This selected language is installed on a PC as a startup language. Subsequently, in step S3, installation of the software such as a driver is performed as usual. After the installation has been completed, in step S4, information on the language selected by the user is written into a startup language table 40 as information on a language to be commonly used as a display language among a plurality of related pieces of software installed on the PC.

Here, the above-described display language is a language displayed while an application is active.

This information on a language to be commonly used as a display language among a plurality of related pieces of software is referred to as a startup language key. That is, the startup language key is a parameter used for setting a common display language for a plurality of correlated pieces of software. The name of a startup language key to be used is written in each of the correlated pieces of software. The CPU extracts the name of a startup language key from one of these correlated pieces of software when executing it, and retrieves a startup language key having the same name as the extracted name from the startup language table. Subsequently, the CPU determines a language to be displayed on the basis of a value of a language corresponding to the startup language key, and displays various information using the determined language. Here, the startup language table is written (registered) in a registry that stores various pieces of setting information of the PC. The startup language key is written in the registry with information of which part of the registry the language key is stored in accordance with the rule about registry writing.

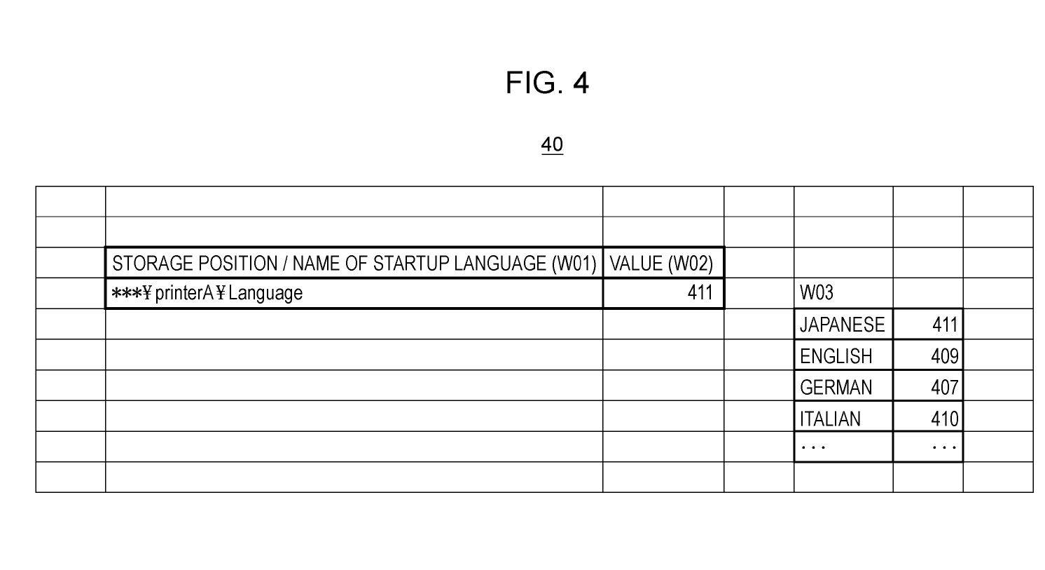

FIG. 4 is a diagram showing an example of the startup language table 40.

The startup language table 40 includes a name of the above-described startup language key W01, a value W02 corresponding to the start up language key, and relationships W03 among startup languages and values thereof.

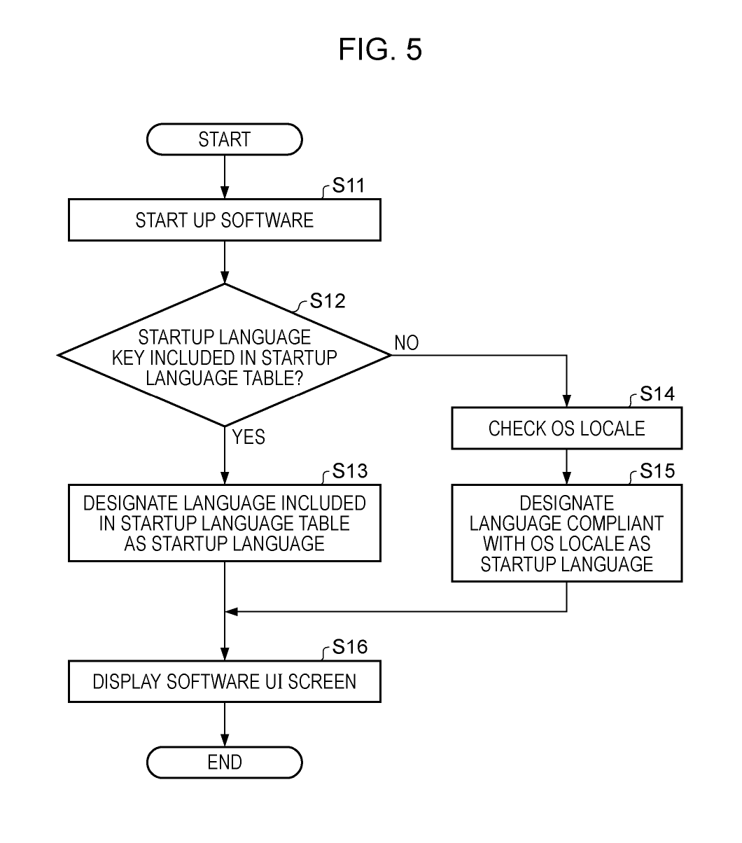

FIG. 5 is a flowchart showing a processing procedure for determining a startup language (display language) at the time of startup of software.

First, software such as a driver or application software is started up on the PC 13 or 14 in accordance with a user's operation. At that time, a CPU performs software startup processing in accordance with the flowchart shown in FIG. 5. In step S11 shown in FIG. 5, the CPU starts up software. In step S12, the CPU checks the startup language table 40 to determine whether a startup language key written in the software started in step S11 is included in the startup language table 40 stored in a registry in the PC. If it is determined that the startup language key written in the software started in step S11 is included in the startup language table 40 (YES in step S12), the CPU sets the language included in the startup language table 40 for the software being started up as the startup language in step S13. In step S16, a driver displays a user interface screen using the set startup language.

After the startup language has been set for the software, if another piece of software related to the software is installed, the value corresponding to the startup language key included in the startup language table 40 is updated with a value corresponding to the language selected by the user in step S2 shown in FIG. 3. Since a plurality of correlated pieces of software refer to the common startup language key written in the startup language table 40, all of these pieces of software display a screen using a language updated on the basis of the updated value corresponding to the startup language key in the startup language table 40.

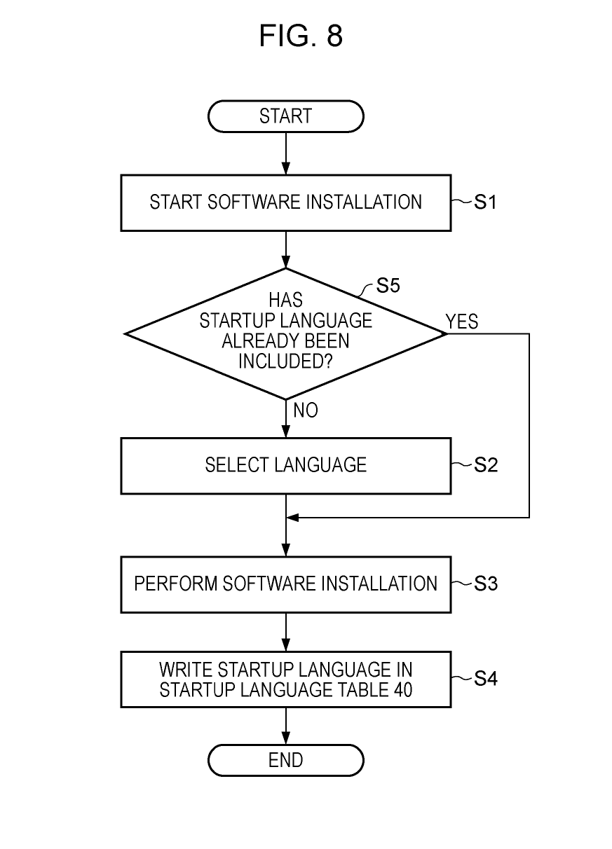

As an exemplary modification of this embodiment, when another related piece of software is additionally installed on the PC, if a startup language key of the software to be additionally installed and a value corresponding to the startup language key have already been included in the startup language table 40 (YES in step S5), it may be determined that language selection in step S2 is not required (a language selection screen may not be displayed for a user). That is, processing of step S2 shown in FIG. 3 may be skipped and then software installation may be performed in step S3 shown in FIG. 3. In this case, the additionally installed software is started using the startup language that has been already written in the startup language table 40 in accordance with the processing procedure shown in FIG. 5. This processing procedure is shown in FIG. 8.

Some pieces of software have not only a function of allowing a user to select a startup language at the time of installation thereof, but also a function of allowing the user to change a language for display (display language) after the installation thereof. For such pieces of software, the startup language table 40 is configured to be updated with a value of a newly selected language when a display language is changed in accordance with a user's operation. Consequently, even if a user changes a display language of software having the function of allowing a user to change a display language, display languages of a plurality of correlated pieces of software can be automatically changed.

If a plurality of correlated pieces of software are downloaded from the Web or the like, and are then installed on a PC, installation and startup processing thereof are similarly performed in accordance with the above-described processing procedure. Accordingly, even if a plurality of correlated pieces of software are downloaded from the Web or the like, display languages of the correlated pieces of software can be automatically changed.

Furthermore, if a user installs software that does not have a function of displaying a language selection screen allowing a user to select a language for the first time (software that does not have a language selection screen) (NO in step S12), it can be considered that a startup language key and the value thereof are not included in the startup language table 40. In this case, at the time of startup of the software, the OS (Operating System) locale of the PC is checked in step S14, and then a language compliant with the OS locale is set as a software startup language in step S15.

Thus, according to the first embodiment, a startup language that has been set when a printer driver is installed first can be matched with a startup language of related software that is subsequently installed.

Furthermore, according to the first embodiment, once a startup language has been set when a printer driver is installed first, the startup language of the related software that is subsequently installed can be matched with the startup language of the printer driver without making a user perform a startup language setting of the related software.

### Second Embodiment

The second exemplary embodiment of the present invention will be described by highlighting differences from the first exemplary embodiment described above. Portions similar to or the same as those described in the first embodiment will not be repeated.

In the first embodiment, a startup language key to be commonly used among a plurality of correlated pieces of software is written in the startup language table. The display languages of these pieces of software are unified on the basis of the startup language key included in the startup language table.

On the other hand, in the second embodiment, a plurality of correlated pieces of software individually have startup language keys, and they are written in the startup language table. If software is additionally installed, all values corresponding to these startup language keys included in the startup language table are updated with a value of a startup language selected at the time of installation of the software. Furthermore, if a user instructs a change in a display language of any one of these pieces of software, all the values are updated with a value of a selected startup language. Thus, display languages can be unified.

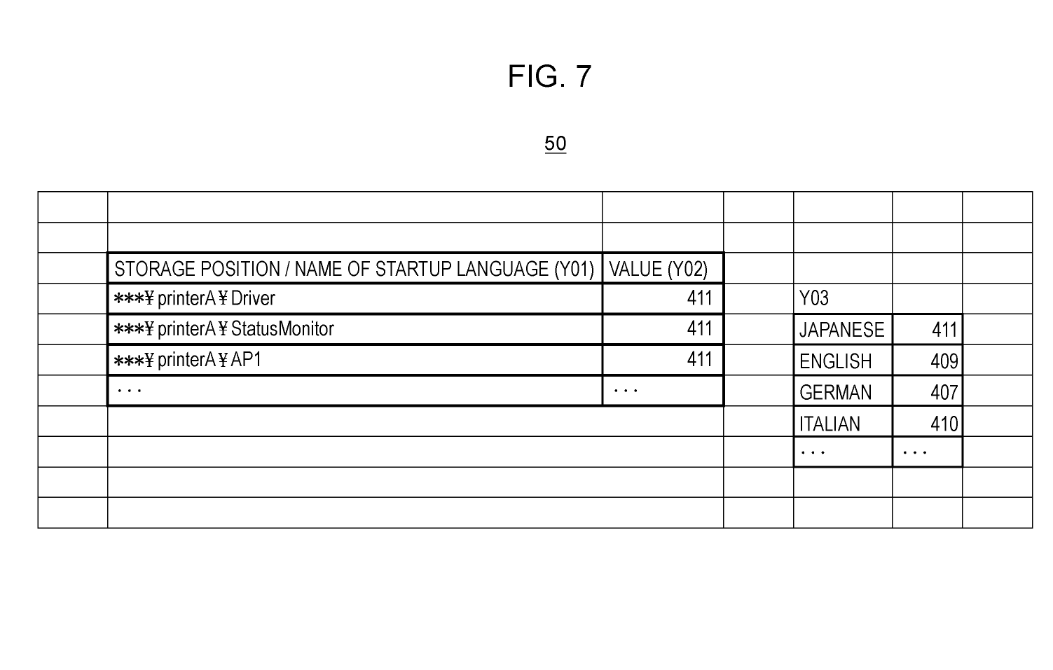

FIG. 7 is a diagram showing an example of a startup language table 50.

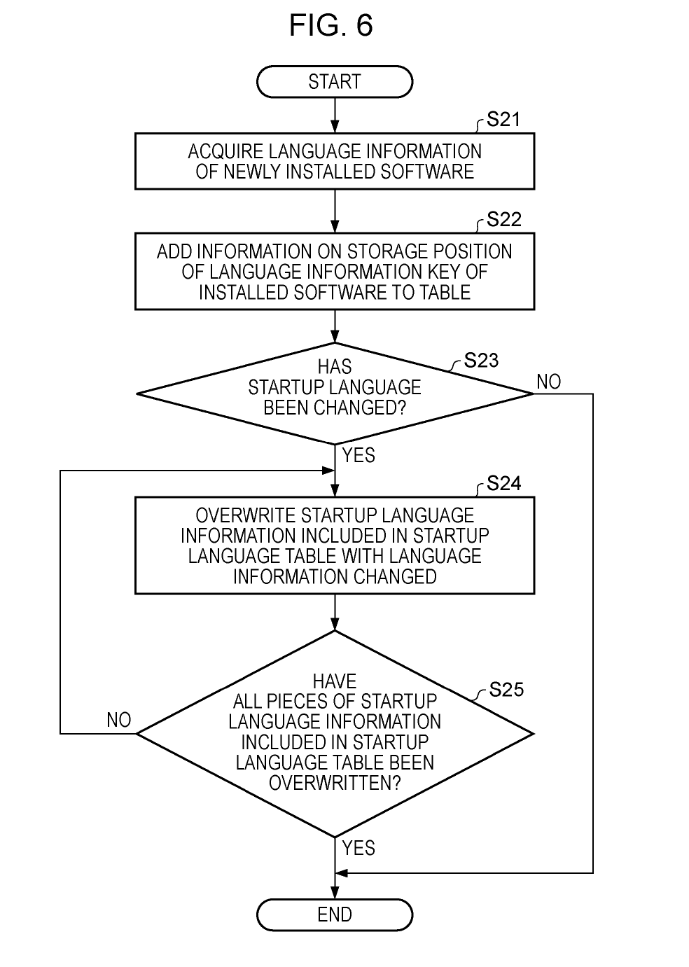

The startup language table 50 includes the names Y01 of startup language keys individually used by correlated pieces of software, values Y02 corresponding to the startup language keys, relationships Y03 among startup languages and their values. Here, the startup language table 50 is written (registered) in a registry that stores various pieces of setting information of the PC. The startup language keys are written in the registry with information on which part of the registry the language keys are stored in accordance with the rule about registry writing. Here, the values Y02 are unified into the same value in accordance with the following processing procedure shown in FIG. 6.

FIG. 6 is a flowchart showing a processing procedure for writing information on a language selected by a user into the startup language table 50 for software installed on a PC.

First, language information set in newly installed software (the name of a startup language key and the value of a selected language) is acquired in step S21. In step S22, the acquired information is written into the startup language table 50. Since this startup language table 50 stores startup language keys of correlated pieces of software along with information of which part of the registry of the startup keys are stored, it can be said that the startup language table 50 is a table for controlling storage positions of startup language keys in a registry. If it is determined in step S23 that a startup language different from a startup language has not been selected (NO in step S23), processing ends. On the other hand, if it is determined in step S23 that a startup language selected in the additionally installed software is different from a startup language that has been set (YES in step S23), one of the values Y02 of startup languages registered in the startup language table is overwritten with the language information of the newly installed software in step S24. In step S25, it is determined whether the overwriting has been performed for all of the pieces of startup language information in the startup language table. If there are still entries in the startup language table to be overwritten (NO in step S25), processing returns to step S24 and the overwriting is performed upon the remaining values Y02 of startup languages registered in the startup language table so as to change the values of the startup languages. Subsequently, when it is determined that the overwriting has been completed (YES in step S25), the process ends.

That is, all of the values Y02 corresponding to software startup languages included in the startup language table 50 are overwritten with this new language information.

As a result, in these pieces of software registered in the startup language table 50, display languages are determined and unified on the basis of the startup language table 50 in accordance with the processing procedure in the flowchart shown in FIG. 6.

If software has not only a function of allowing a user to change a display language at the time of installation thereof, but also a function of allowing the user to change a display language after the installation, the startup language table 50 is similarly updated by startup language table management software when a display language is changed. All of the display languages of correlated pieces of software are changed to the same language.

That is, in the above-described embodiment, a program for checking the startup language table 50 stored at a predetermined position when software is executed is provided.

In the above-described embodiment, each of the correlated pieces of software has a startup language key used for writing a display language. The startup language table 50 is shared by all of these pieces of software. When each of these pieces of software is started, the startup language table 50 is checked. As an exemplary modification of the above-described embodiment, the startup language table 50 may be provided for each piece of software instead of being shared by a plurality of pieces of software. All of these tables may be updated in steps S24 and S25 shown in FIG. 6.

According to the above-described embodiments, each of the correlated pieces of software starts up a user interface (UI) screen using a language written in the startup language table 50. If a language setting of one of these correlated pieces of software is changed by a user, the startup language keys of the other pieces of software are changed in conjunction with the change. Thus, startup languages can be collectively changed without making a user separately perform startup language settings of these correlated pieces of software.

That is, if a plurality of correlated pieces of software are downloaded from the Web and are then installed, and if language selections are not performed at the time of the installation, UI screens are started using the same startup language as that of software that is related to the installed pieces of software and has been installed prior to the installation of these pieces of software. Furthermore, if the startup language is changed when one of the UI screens is started, UI screens are started in all of the correlated pieces of software using the newly selected startup language.

According to the above-described embodiments, display languages of all correlated pieces of software can be easily unified. Furthermore, according to the above-described embodiments, if the display language of one of these pieces of software is changed, the display languages of all of the correlated pieces of software can be collectively changed.

Still furthermore, according to the above-described embodiments, if software is downloaded from the Web and is then installed or is installed later, and if a user does not perform display language setting at the time of the installation, a UI screen can be started using the same display language as that of software that is related to the installed software and has been used. Alternatively, the UI screen can be started using a newly selected display language.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-112283 filed Apr. 14, 2006, which is hereby incorporated by reference herein in its entirety.

What is claimed is:

1. A software display language unification apparatus, comprising:
a selection unit configured to select a language to be used by software for display in accordance with a user's selection;
a language management information storage unit configured to store language management information to be commonly checked by a plurality of pieces of software, the language management information being management information for a language to be used by software;
a checking unit configured to check the stored language management information at the time of startup of software; and
a display language determination unit configured to determine a display language to be used by software being started based on the checked language management information.

2. The software display language unification apparatus according to claim 1,
wherein the language management information includes information on only a single language, and
wherein, when a plurality of pieces of software are individually started up, the checking unit checks the language management information.

3. The software display language unification apparatus according to claim 1, further comprising an updating unit, and
wherein the language management information storage unit stores a plurality of pieces of language management information corresponding to a plurality of pieces of software, and
wherein, when any one of the plurality of pieces of language management information stored in the language management information storage unit is updated, the updating unit updates the other pieces of language management information so that the plurality of pieces of language management information can be unified into management information for an updated language.

4. The software display language unification apparatus according to claim 1, wherein the display language determination unit determines a display language by checking an operating system startup locale when language information for checking has not been stored at the time of startup of software.

5. A software display language unification method, comprising:
selecting a language to be used by software for display in accordance with a user's selection;
storing language management information to be commonly checked by a plurality of pieces of software in a memory, the language management information being management information for a language to be used by software for display;
checking the language management information stored in the memory at the time of startup of software; and
determining a display language to be used by software being started based on the checked language management information.

6. A program stored on a computer-readable medium and having computer-executable instructions for causing a computer to execute procedures for:
selecting a language to be used by software for display in accordance with a user's selection;
storing language management information to be commonly checked by a plurality of pieces of software in a memory, the language management information being management information for a language to be used by software for display;
checking the language management information stored in the memory at the time of startup of software; and
determining a display language to be used by software being started based on the checked language management information.

7. A software display language unification apparatus, comprising:
a selection unit configured to select a language to be used by software for display in accordance with a user's selection;
a language management information storage unit configured to store language management information to be commonly checked by a plurality of pieces of software, the language management information being management information for a language to be used by software for display;
a determination unit configured to determine whether the language management information has been stored; and
a control unit configured to prevent the selection unit from selecting a language in accordance with a user's selection at the time of software installation when it is determined by the determination unit that the language management information has been stored.

8. A software display language unification method, comprising:
selecting a language to be used by software for display in accordance with a user's selection;
storing language management information to be commonly checked by a plurality of pieces of software, the language management information being management information for a language to be used by software for display;
determining whether the language management information has been stored; and
preventing selecting a language in accordance with a user's selection at the time of software installation when it is determined that the language management information has been stored.

9. A program stored on a computer-readable medium and having computer-executable instructions for causing a computer to execute procedures for:
selecting a language to be used by software for display in accordance with a user's selection;
storing language management information to be commonly checked by a plurality of pieces of software, the language management information being management information for a language to be used by software for display;
determining whether the language management information has been stored; and
preventing selecting a language in accordance with a user's selection at the time of software installation when it is determined that the language management information has been stored.
